(19) United States
(12) Patent Application Publication
(10) Pub. No.: US 2007/0194935 A1
(43) Pub. Date: Aug. 23, 2007

(54) HYBRID FREQUENCY CONTACTLESS TRANSPONDER UNIT, MODULE FOR AND METHOD OF MANUFACTURING

(75) Inventors: Stephane Ayala, Palezieus Gare (CH); Jari-Pascal Curty, Nyon (CH)

Correspondence Address: SHERIDAN ROSS PC, 1560 BROADWAY, SUITE 1200, DENVER, CO, 80202, US

(73) Assignee: ASSA ABLOY IDENTIFICATION TECHNOLOGY GROUP AB, Stockholm (CH)

(21) Appl. No.: 11/674,459

(22) Filed: Feb. 13, 2007

(30) Foreign Application Priority Data
Feb. 15, 2006 (EP) 06101722.4
Mar. 31, 2006 (EP) 06112073.9

(51) Int. Cl. G08B 13/14

(52) U.S. Cl. 340/572.8; 340/572.7

(57) ABSTRACT

A contactless transponder unit is provided which comprises a chip module, a first antenna connected to two upper conductive contact zones of the chip module and a second antenna connected to two lower conductive contact zones of the chip module. The chip is configured in such a way as to operate the first antenna at a first frequency range and the second antenna at a second frequency range, the first frequency range being different than the second frequency range.

### FIELD OF THE INVENTION

The invention relates to a module for a contactless transponder unit, a contactless transponder unit with such a module and methods of manufacturing such contactless transponder unit. In particular, the invention concerns hybrid frequency contactless transponder units. As used herein, “hybrid” is understood to refer to contactless transponder units having two different antennas operating in two different frequency ranges. Contactless smart cards are one of the particular embodiments of the invention.

### STATE OF THE ART

The different transmission frequencies of transponders are classified into three basic ranges:
Low Frequency (LF): 30-300 kHz
High Frequency (HF): 3-30 MHz (also called Radio Frequency (RF))
Ultra High Frequency (UHF): 300 MHz-3 GHz (also including Microwave (>3 GHz))

LF and HF antennas are typically loop antennas (made of wire or band), whereas UHF antennas have more varied forms (dipole, patch, slot antenna, etc).

Having systems working at many of these different frequency ranges is a logical follow up of this differentiation. Putting a plurality of mono-range transponders on the same object (support) has long since been state-of-the-art according, for example, to EP 1 267 303 (see paragraph [0003]).

Hybrid frequency transponders, having many antennas working in different frequency ranges and being operated by a single integrated circuit (IC), are the logical next-generation step.

In fact, hybrid frequency contactless transponder units have been state-of-the-art for over a decade. But since the demand on the market for hybrid frequency contactless transponder units has remained marginal for a long time, this kind of product never reached mass production volumes.

The document JP8044831 (1994) describes the principle of hybrid frequency cards, in particular with one UHF/microwave antenna and one LF antenna.

The document U.S. Pat. No. 6,100,788 (1997) describes essentially the same, but with some additional details about the structure of the transponder and the control logic.

In document DE 196 28 802 (1996), the frequency differentiation is coupled to the transmission process, as it shows a LF reception antenna and an UHF emission antenna.

In document EP 1 336 158 (2000), the planar positioning of the different antennae, and in particular their inter-connection is shown.

In document US 2004/0061655, a transponder is secured to a substrate with a temperature sensitive adhesive. When the transponder is secured to the substrate with a temperature sensitive adhesive, the transponder only operates at a first frequency. The temperature sensitive adhesive melts when exposed to a temperature above a predetermined threshold, causing the transponder to decouple from the slot and operate at a second frequency. In fact, this transponder is not able to operate in several frequencies at the same time.

None of these documents show details of how such transponders have to be structured to be suited for mass production processes. In particular, no details about the connection of the antennas to the chip/module or about the structure of chip module needed are given.

On the other hand, there is considerable state-of-the-art regarding another kind of dual mode transponder: the dual contact and non-contact cards. Here, methods of manufacture, chip module structures and connections are abundantly documented such as, for example, in EP 0 671 705, WO97/34247, WO00/25265 and JP2004199114.

All of these documents describe dual contact and non-contact chip modules, having an upper and a lower surface with contact zones, wherein the plurality (8 according to ISO 7816) of upper contacts zones are for contact-using operations and wherein the two lower contact zones are to be connected to the two extremities of an antenna for the non-contact operation.

The central idea of the present invention is to adapt modules, transponder structures and methods of manufacture used for dual contact and non-contact cards to the context and the needs of the hybrid frequency contactless transponder units.

### SUMMARY OF THE INVENTION

It is therefore one aim of the present invention to improve hybrid frequency contactless transponder units and also to improve the known techniques of manufacturing such units.

It is another aim of the present invention to provide a simple and cheap chip module for hybrid frequency transponder units.

In accordance with at least one embodiment of the present invention, a chip module being connectable to at least two different antennas by at least two pairs of conductive contact zones is provided. Each pair of contact zones, all being connected to the chip or to chips present in the module, is placed on one side of the module. Since the connections of the two antennas to the module are geometrically clearly separated, the risk of short-circuits are lower. Transponder units being produced with such a module are more reliable and efficient. Additionally, different cost saving methods of manufacture of a contactless transponder unit with two antennas are possible.

The invention will be better understood in the following description together with the accompanying drawings.

### BRIEF DESCRIPTION OF THE DRAWINGS

FIG. 1A shows one embodiment of a chip module of the invention;

FIG. 1B shows another embodiment of a chip module of the invention;

FIG. 2A shows a top view of a contactless transponder unit in accordance with embodiments of the invention;

FIG. 2B shows a side view of a contactless transponder unit in accordance with embodiments of the invention;

FIG. 3A illustrates a first method of manufacturing according to embodiments of the present invention, showing an exploded view of a chip module connected to a wire antenna ready to be connected to a second antenna, which second antenna is reported on a substrate;

FIG. 3B illustrates a side view of the assembly of a chip module connected to wire a wire antenna and a second antenna;

FIG. 4 shows a cross section of a transponder unit in accordance with embodiments of the present invention, where a chip module is to be placed in the recess of a central layer and connected to two antennas each reported on a substrate to be positioned on both sides of the central layer, all this according a second method of manufacturing of the invention;

FIG. 5 shows a side view of a transponder unit having an insulation layer and two antennae in accordance with embodiments of the invention;

FIG. 6 shows a top view of a transponder unit with a chip module positioned in a recess of an insulation layer from view plane 6-6;

FIG. 7 shows a bottom view of a transponder unit with a chip module positioned in a recess of an insulation layer from view plane 7-7; and

FIG. 8 shows a cross-sectional view of a transponder unit with a chip module positioned in a recess of an insulation layer along section line 8-8.

### DETAILED DESCRIPTION OF THE INVENTION

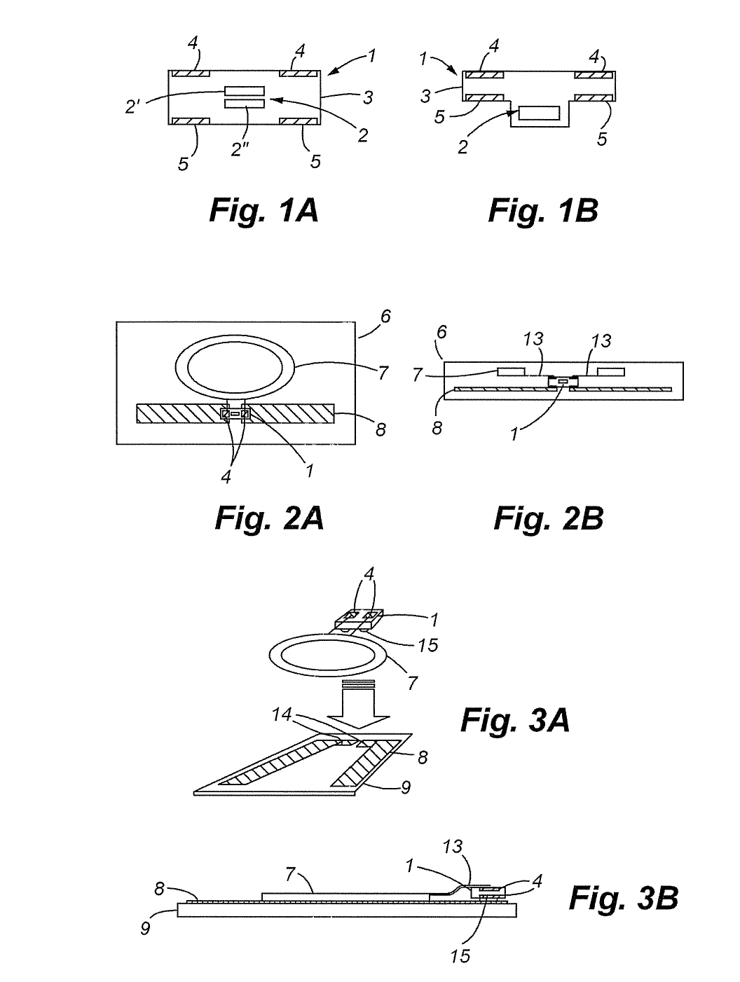

In FIGS. 1A and 1B, two different embodiments of a chip module 1 of the invention are represented. As with all transponder chip modules, they contain at least a transponder chip 2 or two transponder chips 2′ and 2″ embedded in an insulating housing 3, the chip module being connected (not shown) to external conductive contact zones 4 and 5 at the surface of the housing. There are, in fact, two pairs 4 and 5 of contact zones, each positioned on one of the upper and lower surface of the chip module 1. The housing 3 can have many shapes, for example a square with two well defined upper and lower surface as in FIG. 1A, or also T-shaped as in FIG. 1B, in which the lower surface shows different levels. The contact zones 4 and 5 can be placed anywhere on these surfaces, such that each pair is placed on an opposite side of the chip module 1. A symmetrical position of the contact zones as in FIGS. 1A and 1B may be beneficial, but is not required. The internal structures of the chip module, as in particular the connections of the contact zones 4 and 5 to the chip, are not discussed/shown here but are known in the art.

The chip module 1, and more particularly the chip 2 itself, are configured to operate with a first antenna 7 connected to the upper contact zones 4 at a first frequency range and to operate with a second antenna 8 connected to the lower contact zones 5 at a second different frequency range. As an example, the chip 2 represented schematically in FIG. 1 can be in fact made of two individual chips (referenced 2′ and 2″ in FIG. 1A), each individual chip 2′, 2″ being connected to one of the antennas 7, 8. In another variant, the chip 2 can be a single unit programmed to operate both antennas 7, 8. As can be readily understood by a person of skill in the art, both variants given as non-limiting examples (chip made of two individual chips or single unit/chip) can be used in all embodiments described and represented in the present application.

As shown in FIGS. 2A and 2B, the chip module 1 and its two antennas 7, 8 are packaged together as in a contactless transponder unit 6, which can have, for example, the form of a card, although other forms are possible. In this case, the first antenna is a wire loop antenna 7 that is connected to the upper contact zones 4 of the module 1 by the two ends 13 of the wire, and the second antenna is a dipole antenna 8 made of two symmetrical planar conductive surfaces on which the module is positioned. In FIGS. 2A and 2B, both antennas 7, 8 are well separated inside the structure of the contactless transponder card 6. In accordance with one embodiment, the wire loop antenna 7 is a LF (125-135 kHz) antenna, whereas the dipole antenna 8 is an UHF (868-915 MHz) antenna. All other kinds of paired antennas are possible, as long as they are not operated in the same frequency range. Since the two antennas are not positioned at the same higher level and are electrically insulated from each other, there is no particular restriction regarding the geometry of the antennas. Planar antennas are particularly advantageous in the case of a contactless card, but the scope of the invention is not restricted to them.

There are many ways to manufacture a hybrid frequency contactless transponder unit, a particularly advantageous one being illustrated in FIGS. 3A and 3B. According to the embodiment depicted in FIGS. 3A and 3B, a wire loop antenna 7 is connected to the upper contact zones 4 of the module 1. On the other side, a dipole antenna 8 is reported on an insulative substrate 9.

As used in relation to the present invention, “reported” means any technique suitable to form or attach an antenna structure on the substrate 9. The antenna elements can be reported on the substrate 9 according to one or more of the following examples:
printed (by screen printing, by ink jet, etc.)
etched (plasma, electro-plating, etc.)
embedded (in the case of wires for example)
fixed (in the case of a conductive band or metal surface for example)

If as in FIGS. 3A and 3B, the wire used for the loop antenna 7 has an insulation coating (not shown), there is no need for an additional insulating separation between the antennas 7 and 8. In such a case, the module 1 connected to the wire antenna 7 can be directly positioned on the second antenna 8, which is reported on the substrate 9. The second antenna 8 structure shows two contact terminals 14 adapted for positioning the lower contact zones 5 of the module 1 thereto. In the example of FIGS. 3A and 3B, this is achieved by means of a conductive adhesive 15. Ball or stud bonding or even direct bonding (depending on the nature of the material) can also, for example, be used among other possible techniques. In FIG. 3B, the wire antenna 7 (with insulation coated wire) is positioned or relays (e.g., is placed) directly on the substrate 9 and/or partially on the antenna 8. Such a structure and manufacturing process is very simple, efficient and reliable.

In other cases, for example, when the wire is not coated with insulation, an insulation layer with a recess to position the module may be used to isolate both antenna structures. Different embodiments of such processes are discussed below.

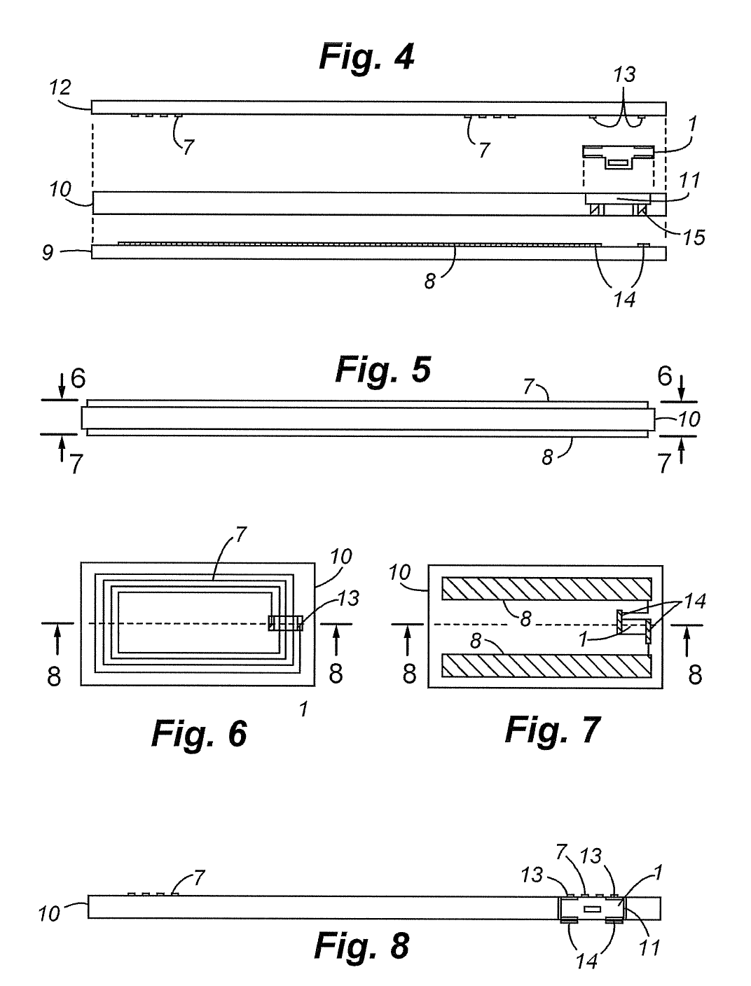

As represented in FIG. 4, an insulation substrate 9 with an antenna structure 8 is provided. The antenna structure 8 shows two contact terminals 14. An insulation layer 10 is provided with a recess 11 and positioned on the substrate 9. In the depicted embodiment, the recess 11 has a T-shape (fitting the chip module 1 of FIG. 1B) and comprises two connection shafts 15. Once the layer 10 is positioned on the substrate 9 and the module 1 is positioned in the recess 11, the conductive material filling the two shafts 15 provides electrical contact between the terminals 14 of the antenna 8 and the lower contact zones 5 of the module 1. Many different types of recesses 11, with or without shafts 15, for example, are possible.

Further shown in FIG. 4 is an upper substrate 12 having an antenna 7 reported on its lower surface. Here, the antenna 7 is typically a HF loop antenna (e.g., with 4 loops) and two ends 13 serving as contacts terminals to be connected to the upper conductive zones 4 of the module when the substrate 12 is positioned on the layer 10. All possible combinations between the different layers 9, 10 and 12 and the recess 11 are possible. Even, for example, using two symmetrical layers 10 with two shafts 15 each, the two substrates 9 and 12 being positioned on the external side of the two layers 10.

In another variant, the antenna 7 can be printed over the upper surface of the layer 10, whereby the two contacts terminals 13 of the antenna 7 are each printed directly on one of the two upper conductive contact zones 4 of the module 1 (the module 1 being previously positioned in the recess 11). In such a case, the substrate 12 is optional and may serve as a protection sheet, for example, in the case of a contactless card.

Another embodiment shown in FIG. 5 illustrates a particularly advantageous method of manufacturing a hybrid frequency contactless transponder unit 6. The transponder unit 6 comprises an insulation layer 10 separating the first antenna 7 from the second antenna.

FIGS. 6 and 7 depict top and bottom views of the transponder unit 6 from the viewing planes 6-6 and 7-7 respectively. Furthermore, FIG. 8 depicts a cross-sectional view of the transponder unit 6 from the sectional view 8-8. As can be seen in FIG. 8, the module 1 is fixed in a recess 11 of the insulation layer 10 in such way that the two upper 4 and the lower 5 conductive contact zones are substantially even with the upper or the lower surface of the layer 10 respectively. Then the antennas 7 and 8 respectively are printed each on each side of the layer 10, wherein the two contact terminals 13 and 14 respectively of each antenna are printed directly on the conductive contact zones 4 and 5 respectively of the module 1 in order to achieve the electrical connection between the antennas 7 and 8 respectively and the chip module 1.

It is advantageous that the contact zones 4 and 5 are even with the respective surfaces of the layer 10 in order allow easy printing of the terminals of the antennas 7 and 8 directly on the contact zones 4 and 5. If, however, the different elements are not even, the printing technique and the ink used may be adapted to allow level changes without disturbing the electrical continuity of the antenna structures.

Referring back to FIG. 6, the upper surface of the insulating layer 10 comprises a HF loop printed antenna 7. With reference to FIG. 7, the lower surface of the insulating layer 10 comprises an UHF dipole printed antenna 8. Even if the antennas chosen are only non-restrictive examples, it should be noted, that they are slightly different with respect to the one presented in the other figures. In particular, the loop antenna 7 has a small part of all its loops printed over the module 1. Only the terminals 13 are printed on the conductive contact zones 4, as the other loops are printed on the non-conductive part of the housing 3 of the module 1.

### LIST OF NUMERICAL REFERENCES

1 chip module
2 transponder chip
2′ transponder chip
2″ transponder chip
3 housing
4 upper conductive contact zones
5 lower conductive contact zones
6 contactless transponder unit
7 first antenna
8 second antenna
9 first insulation substrate
10 insulation layer
11 recess
12 second insulation substrate
13 contact terminal of the first antenna
14 contact terminal of the second antenna
15 connection mean

What is claimed is:

1. A chip module, comprising:
at least one transponder chip in an insulating housing;
said insulating housing having an upper and a lower surface, wherein the upper surface has two upper conductive contact zones to be connected to a first antenna, and wherein the lower surface has two lower conductive contact zones to be connected to a second antenna;
wherein said at least one transponder chip is configured so as to operate the first antenna at a first frequency range and the second antenna at a second frequency range, the first frequency range being different from the second frequency range.

2. The chip module of claim 1, wherein the transponder chip comprises a first chip for operating the first antenna and a second chip for operating the second antenna.

3. The chip module of claim 1, wherein the transponder chip comprises a single chip.

4. A contactless transponder unit comprising a chip module as in claim 1, comprising:
a first antenna connected to the chip module via the two upper conductive contact zones; and
a second antenna connected to the chip module via the two lower conductive contact zones.

5. The contactless transponder unit of claim 4, wherein at least one of the first and second antennas comprise a loop antenna.

6. The contactless transponder unit of claim 5, wherein the at least one loop antenna is a wire antenna.

7. The contactless transponder unit of claim 6, wherein the wire of the wire antenna comprises an insulating coating and wherein the wire antenna is positioned directly to on a substrate on which the second antenna is reported.

8. The contactless transponder unit of claim 4, wherein both the first and second antennas are separated by an insulating layer having a recess in which the chip module is at least partially positioned.

9. The contactless transponder unit of claim 8, wherein both the first and second antennas are printed.

10. A method of manufacturing a contactless transponder unit, comprising:
connecting a first antenna to two upper conductive contact zones of a chip module;
reporting a second antenna on an insulating substrate, the second antenna having two contact terminals; and
positioning the chip module and the first antenna on the substrate such that two lower conductive contact zones of the chip module are electrically connected to the two contact terminals of the second antenna.

11. A method of manufacturing a contactless transponder unit, comprising:
reporting a first antenna on a first surface of an insulating substrate, the first antenna having two contact terminals;
positioning a first surface of an insulating layer comprising a recess over the first antenna;
positioning a chip module in the recess such that two lower conductive contact zones of the chip module are electrically connected to the two contact terminals of the first antenna; and
connecting a second antenna to two upper conductive contact zones of the chip module.

12. The method of claim 11, wherein the second antenna comprises two contact terminals, the method further comprising:
reporting the second antenna on a first surface of a second substrate; and
positioning the first surface of the second substrate on a second surface of the insulating layer such that two upper conductive contact zones of the chip module are electrically connected to the two contact terminals of the second antenna.

13. The method of claim 11, wherein the second antenna is printed on a second surface of the insulating layer, whereby two contact terminals of the second antenna are each printed directly on one of the two upper conductive contact zones of the chip module in order to achieve electrical connection between the second antenna and the chip module.

14. A method of manufacturing a contactless transponder unit, comprising:
positioning a chip module in a recess of an insulating layer such that two upper and two lower conductive contact zones of the chip module are substantially even with one of a first and second surface of the insulating layer respectively;
printing a first antenna over at least a portion of the first surface of the insulating layer, whereby two contact terminals of the first antenna are each printed directly on one of the two upper conductive contact zones of the chip module in order to achieve an electrical connection between the first antenna and the chip module; and
printing a second antenna over at least a portion of the second surface of the insulating layer, whereby two contact terminals of the second antenna are each printed directly on one of the two lower conductive contact zones of the chip module in order to achieve an electrical connection between the second antenna and the chip module.
